(19) United States
(12) Patent Application Publication
(10) Pub. No.: US 2017/0231054 A1
(43) Pub. Date: Aug. 10, 2017

(54) MONEY HANDLING APPARATUS

(71) Applicant: TOSHIBA TEC KABUSHIKI KAISHA, Tokyo (JP)

(72) Inventors: Takeshi HARAGUCHI, Izunokuni Shizuoka (JP); Osamu WATANABE, Fuji Shizuoka (JP)

(21) Appl. No.: 15/404,633

(22) Filed: Jan. 12, 2017

(30) Foreign Application Priority Data
Feb. 5, 2016 (JP) 2016-020780

(51) Int. Cl. H05B 33/08; H05B 37/02; F21V 33/00; G07D 11/00

(52) U.S. Cl. CPC H05B 33/0854; G07D 11/0018; G07D 11/0021; H05B 37/0281; F21V 33/00; F21Y 2115/10

(57) ABSTRACT

According to an embodiment, a money handling apparatus has an illuminating unit and a controller.

The illuminating unit illuminates a support that holds dispensed money by illuminating thereon with light emitted from a light emitting source. The controller turns on the light emitting source of the illuminating unit according to a timing in a money dispensing process.

### CROSS-REFERENCE TO RELATED APPLICATION

This application is based upon and claims the benefit of priority from the prior Japanese Patent Application No. 2016-020780, filed on Feb. 5, 2016, the entire contents of which are incorporated herein by reference.

### FIELD

An embodiment described herein generally relates to a money handling apparatus.

### BACKGROUND

These days, in a place such as a supermarket, there are self checkout apparatuses operated by a customer without a sales assistant for a payment process. Those self checkout apparatuses are called a self checkout device or a Self Point Of Sales (POS), for example. With the self checkout apparatus, the customer inserts and receives money by himself. Thus, regarding such self checkout apparatus, it is important that an insertion opening and a dispensing opening are made easily recognizable.

Conventionally, a blinking guide light or the like is provided near those insertion opening and dispensing opening. However, even with lit guide lights, sometimes the customer takes time to find the insertion opening and the dispensing opening adjacent to the lights. This is particularly significant when the customer is nervous because it is the first time to use of the self checkout apparatus. Further, such a situation can be seen with a device that a customer inserts or dispenses money by himself, which is a money handling apparatus, in addition to the above self checkout apparatus.

### BRIEF DESCRIPTION OF THE DRAWINGS

FIG. 1 is a front view illustrating an external appearance of a self checkout apparatus according to an embodiment.

FIG. 2 is a perspective view illustrating an external appearance of a payment terminal according to the embodiment in a condition that a cover of the payment terminal is open.

FIG. 3 is a perspective view of the external appearance, seen from the above, of the self checkout apparatus according to the embodiment.

FIG. 4 is a perspective view illustrating an external appearance in vicinity of a coin dispense tray of the payment terminal according to the embodiment.

FIG. 5 is a block diagram illustrating a hardware configuration of the self checkout apparatus according to the embodiment.

FIG. 6 is a functional block diagram illustrating a function executed by a controller of the payment terminal according to the embodiment.

FIG. 7 is a flowchart illustrating a payment process executed by the controller of the payment terminal according to the embodiment.

### DETAILED DESCRIPTION

According to an embodiment, a money handling apparatus performs a money receiving process and a money dispensing process. The money handling apparatus includes a housing, a support, an illuminating unit, and a controller. The support supports money dispensed from an inside of the housing outside the housing. The illuminating unit has a light emitting source that emits light. The illuminating unit illuminates the support by illuminating the light emitted from the light emitting source onto the support. The controller turns on the light emitting source of the illuminating unit according to a timing in the money dispensing process.

Hereinafter, an embodiment will be described in detail with reference to the drawings. In the drawings, the same reference numerals represent same or similar parts. As a money handling apparatus according to the present embodiment, a payment terminal (payment device) included in a self checkout apparatus (a self checkout device or a self POS) will be described.

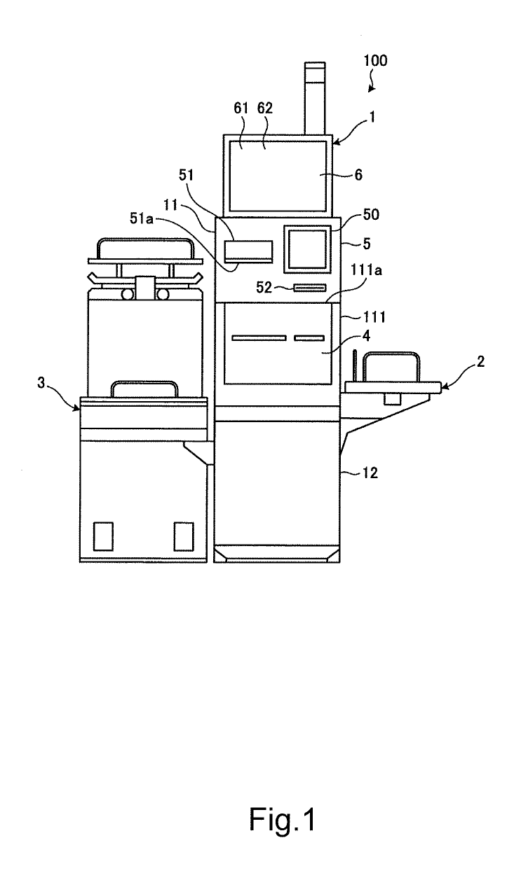

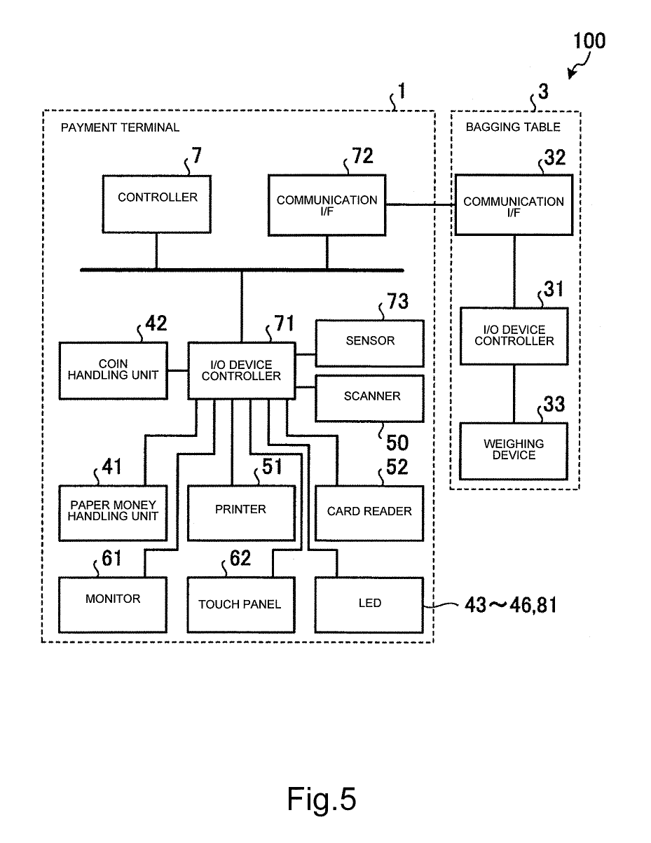

FIG. 1 is a front view illustrating an external appearance of a self checkout apparatus 100 according to the embodiment. As illustrated in FIG. 1, the self checkout apparatus 100 includes a payment terminal (payment device) 1, a basket placement table 2, and a bagging table 3. The payment terminal 1 performs a money receiving process, a money dispensing process or the like for a later described payment process. Here, money includes paper money and coins. The payment terminal 1 includes a money receiving/dispensing unit 4 to perform the money receiving and dispensing processes. Further, the payment terminal 1 includes a reading unit 5, an operation unit 6, and a controller 7 (see FIG. 5), which controls each unit.

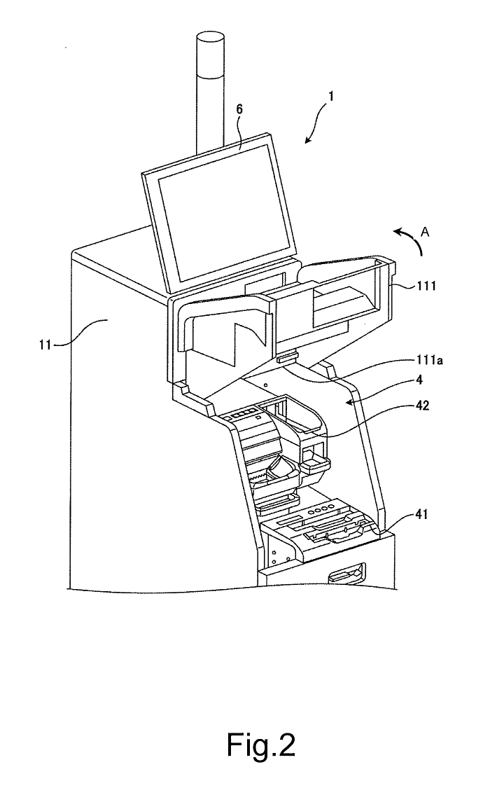

Further, the payment terminal 1 includes a first housing 11 and a second housing 12. The first housing 11 includes a cover 111, which can be kept open or closed. The cover 111 rotates upward and downward about a hinge 111a. The first housing 11 contains the money receiving/dispensing unit 4. The money receiving/dispensing unit 4 includes a paper money handling unit (paper money handling apparatus) 41 and a coin handling unit (coin handling apparatus) 42 (see FIG. 2). Further, the first housing 11 contains the reading unit 5. The second housing 12 contains the controller 7.

The reading unit 5 includes a scanner 50. The scanner 50 reads, from a product, identification information to identify the product. The identification information is, for example, a product code. To the product, an image of an encoded product code, which is a bar code or a sign, is attached. Further, the reading unit 5 includes a printer 51. The printer 51 issues a receipt by printing information related to a product sales data process executed by the controller 7 on a piece of receipt paper. The printer 51 has a receipt support 51a. The receipt support 51a supports an issued receipt. The receipt support 51a is projected from the first housing 11. In other words, the receipt support 51a is a convex-shaped support provided projecting from the first housing 11. Further, the reading unit 5 includes a card reader 52. The card reader 52 reads, from a credit card, information related to the payment process executed by the controller 7.

The operation unit 6 includes a monitor 61 and a touch panel 62. The monitor 61 displays an image according to a control by the controller 7. The touch panel 62 is provided on a surface of the monitor 61. The touch panel 62 outputs, to the controller 7, information based on a position where an operator (a customer, for example) has touched. In other words, the touch panel 62 outputs, to the controller 7, information based on the customer's operation.

The basket placement table 2 is a placement table to place a basket when a customer takes out a product from the basket and holds the product in front of the scanner 50. The basket placement table 2 is provided in one side (in the right side in FIG. 1) of the payment terminal 1.

The bagging table 3 is a placement table used when the customer puts the product in a bag after scanning the product with the scanner 50. The bagging table 3 is provided in the other side (in the different side from the basket placement table 2) of the payment terminal 1.

FIG. 2 is a perspective view illustrating an external appearance of the payment terminal 1 when the cover 111 of the payment terminal 1 is open. As illustrated in FIG. 2, the cover 111 of the first housing 11 is opened by turning upwards (the direction indicated by the arrow A). When the cover 111 is open, the paper money handling unit 41 and coin handling unit 42 in the first housing 11 are exposed. The paper money handling unit 41 and coin handling unit 42 are contained as being laid one on the other in the first housing 11, and the paper money handling unit 41 is placed under the coin handling unit 42.

The paper money handling unit 41 performs a paper money receiving process and a paper money dispensing process. More specifically, in the money receiving process, the paper money handling unit 41 determines whether the received paper money is genuine money. Further, the paper money handling unit 41 stores paper money that is determined as genuine money among the received paper money. Further, in the money dispensing process, the paper money handling unit 41 dispenses paper money as change calculated based on the received money. The coin handling unit 42 performs a coin receiving process and a coin dispensing process. More specifically, in the receiving process, the coin handling unit 42 determines whether received coins are genuine money. Further, the coin handling unit 42 stores the coin that is determined as genuine money among the received coins. Further, in the dispensing process, the coin handling unit 42 dispenses coins as change calculated based on the received coins. The paper money handling unit 41 and the coin handling unit 42 transmit information of an amount of the stored money to the controller 7. An amount of money to be dispensed as change is calculated by the controller 7 based on the received money. Further, the paper money handling unit 41 and the coin handling unit 42 receives, from the controller 7, information of the amount of money to be dispensed as change.

The controller 7 integrally controls each unit in the payment terminal 1, which are, for example, the money receiving/dispensing unit 4, the reading unit 5, and the operation unit 6. The controller 7 acquires a product code from the scanner 50 of the reading unit 5. Further, the controller 7 outputs information to be displayed on the monitor 61 of the operation unit 6. The controller 7 acquires information of the operator's operation from the touch panel of the operation unit 6. Further, the controller 7 recognizes the money received by the paper money handling unit 41 and coin handling unit 42 of the money receiving/dispensing unit 4 and instructs the paper money handling unit 41 and the coin handling unit 42 to dispense money.

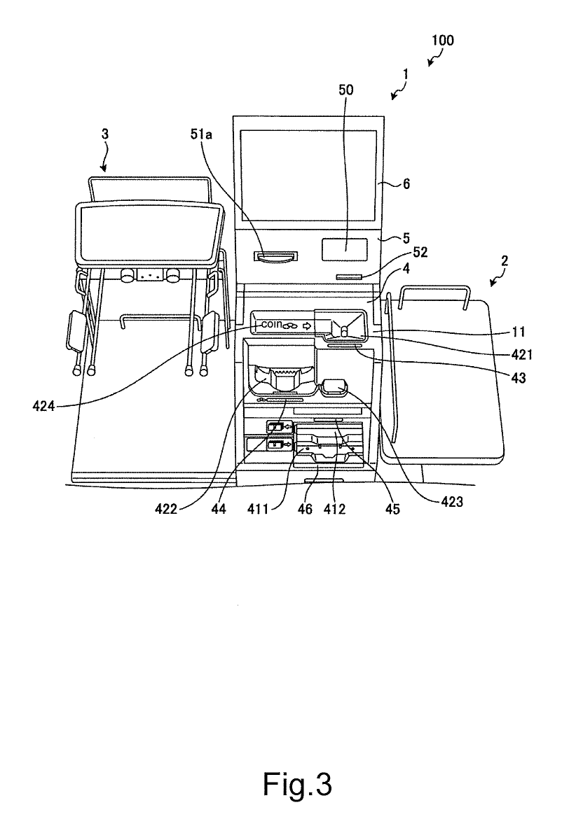

FIG. 3 is a perspective view of the external appearance, seen from the above, of the self checkout apparatus 100. As illustrated in FIG. 3, the money receiving/dispensing unit 4 of the first housing 11 has a coin insertion opening 421. The coin insertion opening 421 is an opening to which a coin to be put to the coin handling unit 42 is inserted. The coin insertion opening 421 is provided at an end on an upper surface of the first housing 11. The coin insertion opening 421 can collectively accept a plurality of coins.

Further, the money receiving/dispensing unit 4 of the first housing 11 has a coin dispense tray 422, a rejection tray 423, a paper money insertion opening 411, and a paper money dispense opening 412. As illustrated in FIG. 3, in the money receiving/dispensing unit 4 in the first housing 11, the coin dispense tray 422 and the rejection tray 423, and the paper money insertion opening 411 and the paper money dispense opening 412 are provided in a step-like manner in order from the back side where the coin insertion opening 421 is placed toward the front side. In other words, the surface where the coin insertion opening 421 is provided is an upper face. The surface where the coin dispense tray 422 and the rejection tray 423 are provided is a middle face. The surface where the paper money insertion opening 411 and the paper money dispense opening 412 are provided is a lower face. By providing the respective types of insertion openings and dispense openings (dispense trays) in a step-like manner as described above, the customer can take a view of all the insertion openings and dispense openings (dispense trays) from the back side to the front side.

The coin dispense tray 422 is a receiving tray to receive coins as change dispensed from the coin handling unit 42. The rejection tray 423 is a receiving tray to receive a coin which is determined as non-genuine money by the coin handling unit 42 (rejected coins). The coin handling unit 42 determines deformed coins, foreign coins, counterfeit coins, and the like as non-genuine money. In other words, the coin handling unit 42 determines those deformed coins, foreign coins, counterfeit coins, and the like as coins which should not be stored. A location relation between the coin insertion opening 421, the coin dispense tray 422, and the rejection tray 423 depends on the structure of the coin handling unit 42.

As illustrated in FIG. 3, the coin dispense tray 422 is provided at an end of the payment terminal 1, in a width direction, where is opposite from the other end where the coin insertion opening 421 is provided. In other words, the coin insertion opening 421 and the coin dispense tray 422 are provided at shifted arrange positions in the height direction, width direction, and depth direction respectively. The above arranged positions can improve a visibility and an operability of the coin dispense tray 422. Here, the rejection tray 423 is provided next to the coin dispense tray 422, below the coin insertion opening 421.

The paper money insertion opening 411 is an insertion opening to which paper money to be put in the paper money handling unit 41 is put (inserted). The paper money dispense opening 412 is a dispense opening where paper money as change is dispensed from the paper money handling unit 41. The location relation of the paper money insertion opening 411 and the paper money dispense opening 412 depends on the structure of the paper money handling unit 41.

Further, as illustrated in FIG. 3, there are guide lights 43, 44, 45, and 46 near the coin insertion opening 421, the coin dispense tray 422, the rejection tray 423, the paper money insertion opening 411, and the paper money dispense opening 412, respectively. The guide lights 43 to 46 are light emitting diodes (LED), for example. Hereinafter, the guide lights 43 to 46 are referred to as LEDs 43 to 46. The LEDs 43 to 46 inform operation procedures and errors. Here, the locations where the LEDs 43 to 46 are provided are not particularly limited as long as provided in vicinity of each unit. Further, the number of the LEDs 43 to 46 and the arrangement thereof are not particularly limited.

When informing an operation procedure, the controller 7 turns on the respective LEDs 43 to 46 at timings when each of the coin insertion opening 421, the coin dispense tray 422, the rejection tray 423, the paper money insertion opening 411, and the paper money dispense opening 412 is used. In other words, the controller 7 controls to turn on the respective LEDs 43 to 46 so that the LEDs 43 to 46 turned on one after the other according to a progress of the operator's operation procedure.

Further, when informing an error, the controller 7 turns on the LEDs 43 to 46 near a unit which is in an error (the coin insertion opening 421, the coin dispense tray 422, the rejection tray 423, the paper money insertion opening 411, or the paper money dispense opening 412).

The payment terminal 1 has a sensor 73 that detects an object (such as a coin) on the coin dispense tray 422 (see FIG. 5). As the sensor 73, an optical sensor, a magnetic sensor, an image sensor, or the like is used. For example, the optical sensor is provided so that an optical axis of the optical sensor runs across on a bottom of the coin dispense tray 422. The optical sensor determines that there is an object on the coin dispense tray 422 when the optical axis is blocked. The magnetic sensor is, for example, placed at a position on a rear side of the bottom face of the coin dispense tray 422. The magnetic sensor determines that there is an object on the coin dispense tray 422 when a metal is detected. The image sensor is placed, for example, above the coin dispense tray 422. The image sensor determines that there is an object on the coin dispense tray 422 by an image recognition.

Here, the paper money insertion opening 411 and the coin insertion opening 421 are examples of openings that take money to be received by the first housing 11. Further, the paper money dispense opening 412, the coin dispense tray 422, and the rejection tray 423 are examples of supports for supporting money dispensed from the first housing 11 outside the first housing 11.

The cover 111 of the first housing 11 has a money placement area 424. The money placement area 424 is provided next to the coin insertion opening 421 in a width direction of the payment terminal 1. The money placement area 424 is generally referred to as a checking area or a coin checking area. When an operation of the payment process is performed with the payment terminal 1, the money placement area 424 is used by the customer to visually check money to be used for the payment by putting thereon the money taken from a wallet, for example.

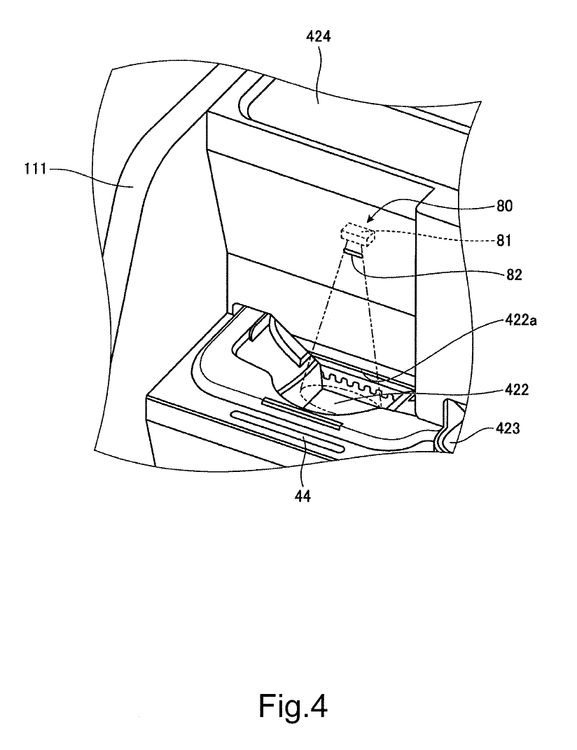

FIG. 4 is a perspective view illustrating an external appearance of vicinity of the coin dispense tray 422 of the payment terminal 1. There is an illuminating unit 80 under the money placement area 424 and above the coin dispense tray 422. The illuminating unit 80 illuminates the coin dispense tray 422 by emitting light to the coin dispense tray 422.

The illuminating unit 80 has a light emitting source 81 and a slit 82. The light emitting source 81 emits light to illuminate the coin dispense tray 422. The light emitting source 81 is an LED. Hereinafter, the light emitting source 81 is referred to as an LED 81. The LED 81 emits blue light, for example. The LED 81 is provided inside the first housing 11. The slit 82 is a hole formed in the cover 111 and lets a part of the light emitted by the LED 81 pass therethrough. In other words, the illuminating unit 80 illuminates the light from the LED 81 onto the coin dispense tray 422 via the slit 82. The slit 82 controls an area where is illuminated by the light emitted from the LED 81.

The LED 81 and slit 82 are provided so that the light that is emitted from the LED 81 and passes though the slit 82 illuminates a predetermined area on the coin dispense tray 422. With this structure, the illuminating unit 80 illuminates the predetermined area as if focusing a spotlight.

Further, the illuminating unit 80 illuminates the predetermined area from the rear side toward the front side and from the above towards the lower side, not from the right above. More specifically, the LED 81 and the slit 82 are arranged at predetermined positions. The predetermined positions are positions that the light emitted from the LED 81 and reflected on a surface of a coin on the coin dispense tray 422 and the coin dispense tray 422 enters eyes of the operator (for example, an adult woman of an average height) who is using the self checkout apparatus 100. This arrangement causes a condition that many customers feel brightness from the coin dispense tray 422 and the change. Thus, this makes the customers easily focus on the change and it is less likely to forget to take the change.

Next, a hardware configuration of the self checkout apparatus 100 will be explained.

FIG. 5 is a block diagram illustrating the hardware configuration of the self checkout apparatus 100.

As illustrated in FIG. 5, the payment terminal 1 includes the controller 7, an input/output (I/O) device controller 71, and a communication interface (I/F) 72. The communication I/F 72 communicatably connects the payment terminal 1 to the bagging table 3. The I/O device controller 71 connects the controller 7 and the paper money handling unit 41, the coin handling unit 42, the LEDs 43 to 46, 81, the scanner 50, the printer 51, the card reader 52, the monitor 61, the touch panel 62, and the sensor 73.

The bagging table 3 has an I/O device controller 31, a communication interface (I/F) 32, and a weighing device 33. The weighing device 33 weights an item placed on the bagging table 3. The communication I/F 32 communicatably connects the bagging table 3 and the payment terminal 1. In other words, the I/O device controller 31 connects the weighing device 33 to the controller 7 via the communication I/Fs 32 and 72. The weighing device 33 weights the item on the bagging table 3 in purpose of fraudulence prevention.

The controller 7 includes a central processing unit (CPU), a read only memory (ROM), and a random access memory (RAM). The ROM stores various computer programs to be executed by the CPU and various data. The RAM temporarily stores the data and computer program when the CPU executes the computer program. The controller 7 integrally controls each unit by developing, in the RAM, the computer programs that are read by the CPU from the ROM and executing the program.

Here, the computer program executed in the self checkout apparatus 100 according to the present embodiment is stored and provided in a computer-readable recording medium such as a CD-ROM, a flexible disk (FD), a CD-R, a digital versatile disk (DVD) in a file of an installable format or an executable format.

Further, the computer program executed in the self checkout apparatus 100 according to the present embodiment may be stored in a computer connected to a network such as the Internet and provided by being downloaded via the network. Further, the computer program executed in the self checkout apparatus 100 according to the present embodiment may be provided or distributed via the network such as the Internet.

Further, the computer program executed in the self checkout apparatus 100 according to the present embodiment may be installed in a ROM or the like in advance and provided.

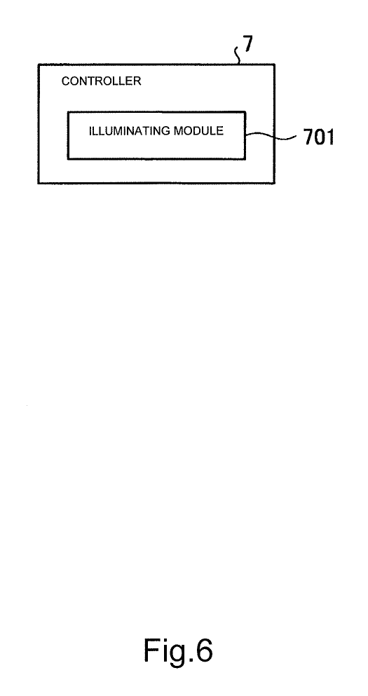

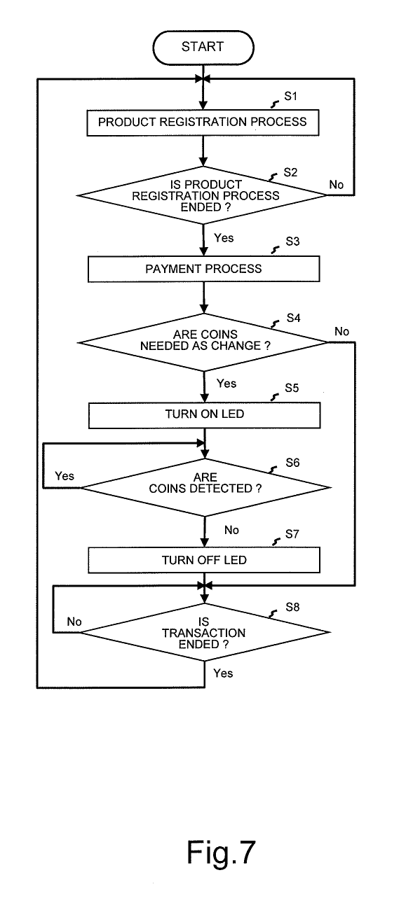

Next, the payment process which is a characteristic function of the present embodiment among the various processes executed by the controller 7 of the payment terminal 1 in the self checkout apparatus 100 will be explained. FIG. 6 is a functional block diagram illustrating a function of the payment process executed by the controller 7 of the payment terminal 1. FIG. 7 is a flowchart illustrating the payment process executed by the payment terminal 1.

In the payment process, as illustrated in FIG. 6, the controller 7 of the payment terminal 1 serves as an illuminating module 701 by following the computer program.

The illuminating module 701 turns on the LED 81 at timing when a target (which is, the coin dispense tray 422 and the change) is needed to be paid attention. The timing when attention is needed is the timing corresponding to the money dispensing process executed by the coin handling unit 42. Further, the illuminating module 701 continues the lighting by the LED 81 in a period while the sensor 73 is detecting an object. Here, the period is while a coin or the like exists on the coin dispense tray 422, that is, while the coin dispense tray 422 is holding the object, which is assumed as a coin.

The payment process executed by the controller 7 of the payment terminal 1 will be explained with reference to the flowchart illustrated in FIG. 7. As illustrated in FIG. 7, firstly in step S1, the controller 7 of the payment terminal 1 executes a product registration process.

Here, the product registration process will be explained. When the customer holds an image in which a product code is encoded in front of the scanner 50, the scanner 50 reads the encoded image (a bar code or the like) and outputs the product code. When the scanner 50 outputs the product code, for example, the controller 7 refers to a price look up (PLU) file stored in a storage unit of the payment terminal 1 or an external device connected online. The PLU file records product information such as a name, a price, and the like of the product in a format of a table, for example, as associating the information with the product code.

Next, the controller 7 acquires the product information that is read by the scanner 50 and associated with the product code among the product information recorded in the PLU file. Then, the controller 7 records the product information as purchased product information and adds the price of the product to a purchased amount. In this manner, the product registration process is performed.

When the customer finishes operating the product registration process and bagging the products, for example, the customer performs an operation on the touch panel 62 to instruct to end the product registration process. In step S2, the controller 7 of the payment terminal 1 determines whether or not the operation to instruct to end the product registration process is performed on the touch panel 62. When it is determined that the operation to instruct to end the product registration process is performed (step S2, Yes), the process of the controller 7 proceeds to step S3. In step S3, the controller 7 performs the payment process. When it is determined that the operation to instruct to end the product registration process is not performed (step S2, No), the process of the controller 7 returns to step S1.

Here, the payment process will be explained. When the touch panel 62 receives an operation by the customer to proceed to a payment process, the controller 7 of the payment terminal 1 displays a payment amount which is a total of the prices of the products recorded in the monitor 61. In a case of the present embodiment, for example, when receiving an operation to instruct to end the product registration process, the controller 7 displays a payment amount which is a total of the prices of the products recorded in the monitor 61. In this manner, the controller 7 of the payment terminal 1 starts to receive an operation for the payment process by the customer.

In a case of a cash payment, when money is put to the paper money insertion opening 411 of the paper money handling unit 41 and the coin insertion opening 421 of the coin handling unit 42, the controller 7 calculates a difference between the received money and the payment amount (change). When there is change as a result of the calculation, the controller 7 controls the money handling units 41 and 42. The controller 7 controls the money handling units 41 and 42 to dispense paper money as change from the paper money dispense opening 412 and coins as change from the coin dispense tray 422.

After the difference between the inserted money and the payment amount is calculated in the payment process, in step S4, the controller 7 determines whether coins as change are needed. When it is determined that coins as change is needed (step S4, Yes), the process of the controller 7 proceeds to step S5. In step S5, the controller 7 serves as the illuminating module 701. In other words, when the coins as change are dispensed to the coin dispense tray 422 by the coin handling unit 42, the controller 7 turns on the LED 81.

Next, in step S6, the controller 7 determines whether or not there is an object (coins) on the coin dispense tray 422 by checking the output from the sensor 73. While the sensor 73 is detecting that there is an object on the coin dispense tray 422, the controller 7 determines that there is an object on the coin dispense tray 422 (step S6, Yes). The controller 7 continues a lighting condition of the LED 81. Further, when it is not detected that there is an object on the coin dispense tray 422 (step S6, No), the process of the controller 7 proceeds to step S7. In step S7, the controller 7 turns off the LED 81.

After turning off the LED 81 in step S7 and when it is determined that the coins as change are not needed (step S4, No), the process of the controller 7 proceeds to step S8. In step S8, the controller 7 determines whether or not the transaction is ended. The controller 7 determines that one transaction is ended based on the completion of the payment process. When it is determined that the transaction is not ended (step S8, No), the controller 7 waits until the transaction is ended. When it is determined that the transaction is ended (step S8, Yes), the process of the controller 7 returns to step S1. The controller 7 waits until a next transaction starts.

As described above, the money handling apparatus (payment terminal 1) according to the present embodiment turns on the LED 81 and illuminates the coin dispense tray 422 according to a timing process of dispensing money to the coin dispense tray 422 of the coin handling unit 42. Thus, according to the present embodiment, attention of the customer as an operator can be directed to a proper part, that is, the coin dispense tray 422 (the change) at a proper timing. Since the illumination by the LED 81 can directly illuminate a target compared to one that illuminates in vicinity of the target such as a guide light (LEDs 43 to 46), it can more sufficiently prevent the change from being left without taken.

Here, in a case that the coin dispense tray 422 and the vicinity thereof are composed of a black material, since the coins illuminated by blue light looks sharp and clear, it is further effective to prevent the change from being left without taken.

Further, the color of the light emitted by the LED 81 does not have to be blue and may be other colors such as yellow, for example. The illumination of the light of blue or yellow for guiding is less likely to make people feel uncomfortable, a situation that the change is unseen can be prevented while suppressing the increase of uncomfortableness due to the additionally provided light for guiding. To further enhance this effect, the LED 81 may blink, not being simply turned on.

Further, according to the present embodiment, the illuminating unit 80 that illuminates the coin dispense tray 422 is described as an example; however, the embodiment is not limited by this example. In other words, the money handling apparatus may have an illumination unit that illuminates the openings (the paper money insertion opening 411 and coin insertion opening 421) and may have an illuminating unit that illuminates another support body (the paper money dispense opening 412). Further, in that case, the timing of turning on the illuminating unit may be synchronized with the timing to turn on the LEDs 43 to 46 serving as guide lights.

Further, according to the present embodiment, the LED 81 is used as an example of the light emitting source of the illuminating unit 80; however the light emitting source of the illuminating unit 80 is not limited to this example and other light emitting sources may be used. Further, the illumination area of the illuminating unit 80 may be restricted by using a light emitting source that emits light having a high directivity, without restricting the illumination area with the slit 82. Further, the illumination by the illuminating unit 80 is not limited to the direct illumination from the light emitting source. That is, the illuminating unit 80 may indirectly illuminate the predetermined area by using a condenser lens, a reflector, or the like.

Further, the illuminating unit 80 is placed at a position so that the light, which is emitted by the light emitting source (LED 81) and reflected on the coin dispense tray 422 or a surface of the coins on the coin dispense tray 422, enters eyes of the operator (for example, an adult woman of an average height) who is using the self checkout apparatus 100. Here, when the entering angle of the regular reflection light with respect to the eyes of the operator does not satisfy the above described placement condition, the problem may be solved by using a light emitting source that emits a sufficient amount of light.

Here, an example in which the money handling apparatus according to the present embodiment is applied to the payment terminal 1 of the self checkout apparatus 100 for the product registration process and payment process operated by the customer him/herself has been explained; however, the present embodiment is not limited to this example. For example, the money handling apparatus according to the present embodiment may be placed at a semi-self checkout lane and be applied to an accounting machine with which a customer performs the payment process after a sales assistant performs the product registration process.

Further, the money handling apparatus according to the present embodiment may be applied to a ticket vending machine (a ticketing device) that issues food tickets of an eating place or the like. Further, the money handling apparatus according to the present embodiment may be applied to an exit fare machine and a vending machine of a parking facility or a station.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A money handling apparatus that performs a money receiving process and a money dispensing process, comprising:
a housing;
a support configured to support money dispensed from an inside of the housing outside the housing;
an illuminating unit configured to have a light emitting source that emits light and illuminate the support by illuminating the light emitted from the light emitting source onto the support; and
a controller configured to turn on the light emitting source of the illuminating unit according to a timing in the money dispensing process.

2. The money handling apparatus according to claim 1, wherein the controller turns on the light emitting source when money is dispensed onto the support from the inside of the housing.

3. The money handling apparatus according to claim 2, further comprising
a sensor configured to detect whether or not there is money held by the support,
wherein the controller turns on the light emitting source when the sensor detects that there is money being held by the support.

4. The money handling apparatus according to claim 3, wherein the controller turns off the light emitting source when the sensor detects that there is no money being held by the support.

5. The money handling apparatus according to claim 1, wherein
the controller
determines whether the money dispensing process is needed based on money received in the money receiving process, and
turns on the light emitting source when it is determined that the money dispensing process is needed.

6. The money handling apparatus according to claim 2, wherein the controller continues to turn on the light emitting source while money is being held by the support.

7. The money handling apparatus according to claim 1, wherein the light emitting source of the illuminating unit emits blue light or yellow light.

8. The money handling apparatus according to claim 1, wherein the illuminating unit has a slit to restrict an area to be illuminated by the light from the light emitting source.

9. The money handling apparatus according to claim 8, wherein
the light emitting source is provided in the housing, and
the illuminating unit illuminates the support with the light from the light emitting source through the slit.

10. The money handling apparatus according to claim 9, wherein
the light emitting source and the slit are provided at predetermined positions, and
the predetermined positions are positions realizing that the light, which is emitted from the light emitting source and right reflected by the money held by the support, enters eyes of an operator.

11. The money handling apparatus according to claim 1, further including
an insertion opening provided to the housing to have money received into the housing;
a dispense opening provided to the housing to have money dispensed outside the housing; and
a plurality of guide lights provided in each vicinity of the insertion opening and the dispense opening,
wherein
the controller controls to turn on the plurality of guide lights so that the guide lights to be turned on are switched according to a progress of an operator's operation procedure.
